(19) United States
(12) Patent Application Publication
(10) Pub. No.: US 2025/0198875 A1
(43) Pub. Date: Jun. 19, 2025

(54) SENSOR WITH VALVE RELEASE SYSTEM AND METHOD

(71) Applicant: Mueller International, LLC, Atlanta, GA (US)

(72) Inventors: Mohammad Hassan Sobhani, Toronto (CA); Daryl Lee Gibson, Chattanooga, TN (US)

(21) Appl. No.: 18/540,201

(22) Filed: Dec. 14, 2023

(51) Int. Cl. G01M 3/24

(52) U.S. Cl. CPC G01M 3/243

(57) ABSTRACT

A sensor assembly comprising a sensor housing configured to couple to a pipe, a sensor mounted on the sensor housing and configured to measure a parameter, and a pressable valve mounted on the sensor housing and selectively movable from a closed configuration to an open configuration.

### TECHNICAL FIELD

This disclosure relates to sensors in a utility system. More specifically, this disclosure relates to coupling of a sensor into a utility system, such as a water utility.

### BACKGROUND

A municipal utility system (e.g., a water system) can include various complex components designed to collect, treat, and distribute water to residences, businesses, and/or other facilities, e.g., within a city or town. The water or other utility must be sourced, cleaned, and distributed to each facility, usually through piping components. The quality and quantity of the source water can significantly impact the operation of the municipal water system, and regular inspections and maintenance of the system can ensure that the structure is safe and efficiently providing residents with potable drinking water. Since each component of the utility system plays a crucial role in delivering safe, reliable water supplies, the system should be carefully managed and maintained to protect public health, support economic activity, and/or safeguard the environment.

One method of managing and inspecting a utility system involves a sensor, such as a microphone adapted to function in a liquid environment. Such microphone sensors are typically referred to as hydrophones. A sensor, such as a hydrophone, is a type of microphone specifically designed to be used underwater to record and/or listen to underwater sounds. Many sensors of this type, including hydrophones, utilize a piezoelectric transducer that generates an electric potential when subjected to a pressure change, such as an underwater sound wave. The sensor can detect leaks by listening to the sounds generated by escaping water or gas. In some examples, hydrophones can pinpoint the leak location along a pipeline, which can be especially useful for large-scale infrastructure like water mains or oil and gas pipelines, where leaks can lead to significant economic and environmental damage.

Sensors such as hydrophones can also be used to monitor the integrity of the pipeline. For example, sounds made by a pipeline can give clues to its overall health. Changes in the usual noise level can indicate a problem with the pipeline's operation, a blockage, and/or an improperly functioning valve. In some cases, hydrophones and other sensors can monitor pipelines for signs of tampering and/or unauthorized activity. For example, the hydrophone system could detect the sound of drilling or other mechanical work. Fluid sensors and hydrophones can benefit research and development testing of plumbing systems or technologies, for example, to study the effects of different flow rates or pressures on the noise produced by a system. In addition, when air (or other compressible fluid) builds up, it dampens the signal obtained by the sensor.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is a sensor assembly comprising a sensor housing configured to couple to a pipe, a sensor mounted on the sensor housing and configured to measure a parameter, and a pressable valve mounted on the sensor housing and selectively movable from a closed configuration to an open configuration.

In a further aspect, disclosed is a system comprising a pipe conducting a fluid, a sensor housing coupled to the pipe, a sensor mounted on the sensor housing and configured to measure a parameter of the fluid within the pipe, and a pressable valve mounted on the sensor housing and selectively movable from a closed configuration to an open configuration.

In yet another aspect, disclosed is a method comprising coupling a sensor assembly to a pipe, the sensor assembly comprising a sensor and a pressable valve within a sensor housing, and depressing the pressable valve to selectively move the pressable valve from a closed configuration to an open configuration.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, serve to explain various principles of the disclosure. The drawings are not necessarily drawn to scale. Corresponding features and components throughout the figures may be designated by matching reference characters for the sake of consistency and clarity.

FIG. 1 is a perspective view of a system to quickly connect and monitor a sensor assembly, in accordance with one aspect of the current disclosure.

FIG. 2 is an elevated side view of the sensor assembly of FIG. 1.

FIG. 3 is a cross-sectional view of the sensor assembly of FIG. 1 in the closed configuration and taken along line 3-3 of FIG. 1.

FIG. 4 is a cross-sectional view of the sensor assembly of FIG. 1 in the open configuration and taken along line 3-3 of FIG. 1.

FIG. 5 is an elevated side view of another sensor assembly in accordance with another aspect of the current disclosure.

FIG. 6 is a cross-sectional view of the sensor assembly of FIG. 5 in a closed configuration and taken along the axis line 3-3 of FIG. 1.

FIG. 7 is a cross-sectional view of the sensor assembly of FIG. 5 in an open configuration and taken along the axis line 3-3 of FIG. 1.

FIG. 8 is an elevated side view of another sensor assembly in accordance with another aspect of the current disclosure.

FIG. 9 is a cross-sectional view of the sensor assembly of FIG. 8 in a closed configuration and taken along the axis line 3-3 of FIG. 1.

FIG. 10 is a cross-sectional view of the sensor assembly of FIG. 8 in an open configuration and taken along the axis line 3-3 of FIG. 1.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

In one aspect, a sensor assembly and associated methods, systems, devices, and various apparatuses are disclosed herein. In one aspect, the sensor assembly can comprise a method for removing compressible fluid (e.g., gas) from a working fluid line (e.g., an incompressible fluid such as water) and can be configured to facilitate easy and/or quick installation on pre-existing pipes.

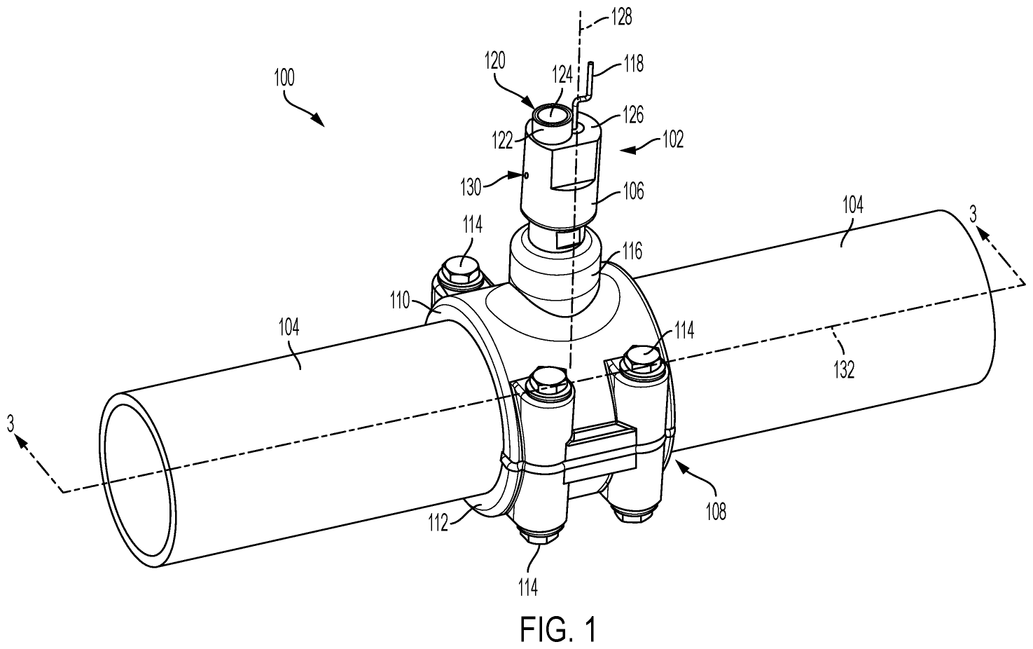

One aspect of a system 100 for releasing a fluid from a sensor assembly 102 is disclosed and described in FIG. 1. The system 100 comprises sensor assembly 102 coupled to a pipe 104. The sensor assembly 102 is coupled to system 100 and configured to conduct incompressible fluid through pipe 104. For example, sensor assembly 102 can intermittently release any accumulated compressible fluid from pipe 104 through a sensor housing 106. In various aspects, the released fluid can comprise incompressible and/or compressible fluids.

The sensor housing 106 can be coupled to the pipe 104 with a saddle 108. An exemplary saddle 108 is illustrated in FIG. 1, but any desired saddle 108 or other known configuration for mounting a sensor housing 106 on a pipe 104 can be used in other aspects. In the current aspect, the saddle 108 can comprise an upper cap 110 and/or a lower cap 112. In the illustrated aspect, fasteners 114 (e.g., bolts, nuts, T-fittings, sealing adhesive, and/or friction fit, etc.) can couple the upper cap 110 to the lower cap 112. This configuration can facilitate the installation of the saddle 108 onto pre-existing pipe 104. Other systems and/or methods of coupling the sensor housing 106 are considered. For example, the saddle 108 can comprise a branch 116 that couples directly to the sensor housing 106 and/or couples to an extension of pipe 104 (e.g., with a smaller diameter and/or in a transverse direction) that couples directly to the sensor housing 106. Pipe 104 or another suitable connector/connection can couple the sensor housing 106 to pipe 104 (e.g., at a branch 116, saddle 108, and/or another fitting). In other aspects, the sensor housing 106 can attach directly to a portion of the pipe 104, such as a monolithic branch or extension of the pipe 104.

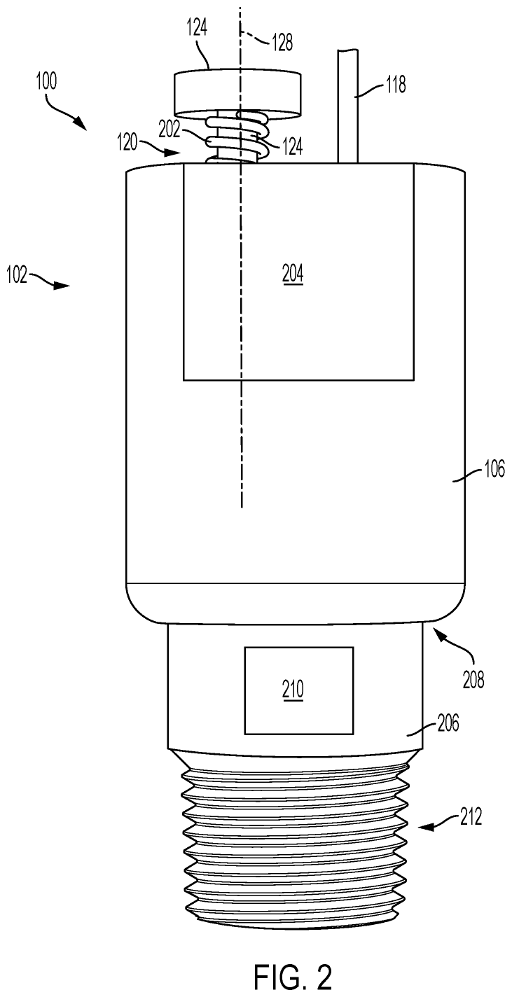

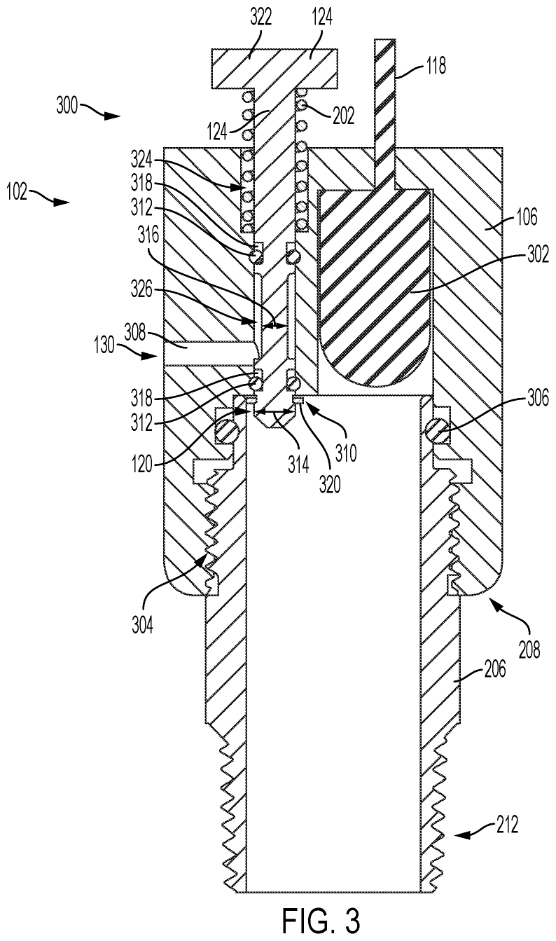

FIG. 2 is an elevated view of the sensor assembly 102, and FIG. 3 shows a cross-section of a sensor 302 of the sensor assembly 102. The sensor 302 can be mounted inside the sensor housing 106. The sensor 302 is configured to measure a parameter of the fluid within pipe 104 and is secured in contact with the working fluid by the sensor housing 106. An electric cable 118 extends to sensor 302 and can traverse through a surface of the sensor housing 106 to power and/or transmit an electronic signal to or from sensor 302.

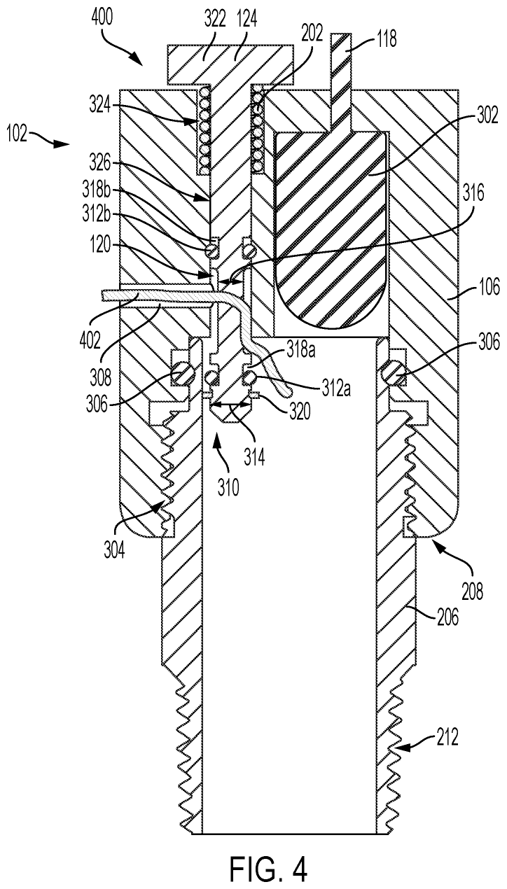

Turning back to FIG. 1, a button valve, e.g., pressable valve 120, is mounted to the sensor housing 106. The pressable valve 120 can comprise a protective enclosure, shown as cover 122. Cover 122 can surround and/or partially surround a button valve stem or stem 124. A biasing element (e.g., shown as spring 202) can surround stem 124 and/or be selectively movable from and between a closed configuration 300 (FIG. 3) to an open configuration 400 (FIG. 4).

The sensor housing 106 defines a top surface 126. In some aspects, the sensor 302 and/or the pressable valve 120 can extend through the top surface 126 of the sensor housing 106 into the interior of the sensor housing 106. The top surface 126 can comprise the cover 122 surrounding the pressable valve 120 to facilitate the release of a compressible fluid (e.g., air or another captured gas). The pressable valve 120 can define a central axis 128 extending through the sensor housing 106 to create a flow path exit 130 that ejects compressible fluid from pipe 104, e.g., in a direction different from an axial direction of the central axis 128. In various aspects, the pressable valve 120 defines a transverse flow path 308 and directs an escaping fluid out of the sensor housing 106 in a substantially transverse direction to the central axis 128 in the open configuration 400.

FIG. 2 illustrates a tool landing surface 204 on the sensor housing 106 that can be used to torque the sensor housing 106, e.g., onto a saddle 108 (FIG. 1). Similarly, a modular connector 206 can be affixed to a bottom 208 of the sensor assembly 102. The modular connector 206 can comprise a modular tool surface 210, the same or similar to the tool landing surface 204 on the sensor assembly 102. For example, the sensor assembly 102 can be coupled to the modular connector 206 to conform an inner portion (e.g., inner threads 304 shown in FIG. 3) of the sensor housing 106 to connect the sensor housing 106 to the pipe 104. Tool landing surface 204 of the sensor housing 106 and modular tool surface 210 can each be configured to receive a wrench and be torqued in opposite directions (e.g., clockwise and counterclockwise). Similarly, tool landing surface 204 and/or modular tool landing surface can be rotated onto a fitting, such as saddle 108 (FIG. 1), to couple sensor housing 106 to pipe 104. Modular connector 206 facilitates coupling the same sensor housing 106 onto various pipes and/or fitting sizes and types.

The modular connector 206 can comprise standardized external threads, referred to as threads 212, that can facilitate coupling the sensor assembly 102 to various sizes of pipes 104 and/or fittings. The modular tool surface 210 can rotate modular connector 206 relative to sensor housing 106 to facilitate coupling and/or torquing of the modular connector 206. Modular connector 206 can facilitate coupling the sensor housing 106 to a standard fitting (e.g., saddle 108 or pipe 104 of FIG. 1) and/or change the threads 212 of the sensor housing 106 to fit a different existing connection. For example, threads 212 on modular connector 206 can be tapered to facilitate the installation onto an existing fitting.

FIG. 3 is a cross-sectional view of the pressable valve 120 in a closed configuration 300. FIG. 4 is a cross-sectional view of the pressable valve 120 of the sensor assembly 102 in the open configuration 400. The cross-sections in FIGS. 3 and 4 are taken along line 3-3, which extends through pipe axis 132 of the installed sensor assembly 102, as shown in FIG. 1. Line 3-3 extends through pipe axis 132 of the sensor assembly 102 to identically compare different assemblies, e.g., sensors in sensor housings, as shown in FIGS. 1, 5, and 8. The sensor assemblies 102 described herein can be installed on the saddle 108 of FIG. 1, and the cross-sections show the same or similar cross-sectional orientation for comparison.

With reference to FIGS. 3 and 4, external threads 212 on the modular connector 206 can threadedly engage internal threads, or inner threads 304, of the sensor housing 106. An inner seal 306 can seal the modular connector 206 within the sensor housing 106. The sensor 302 can extend through sensor housing 106 and can be immersed in an incompressible fluid in the modular connector 206 and/or pipe 104. In various aspects, any compressible fluids that are trapped in the modular connector 206 and/or pipe 104 can rise towards the sensor 302 and be released (e.g., “bleed out”) from system 100 through the flow path 308 that is opened when the stem 124 of pressable valve 120 is compressed and moved into the open configuration 400. In the closed configuration 300 of FIG. 3, the flow path 308 can be blocked and sealed by a sealing bracket or a bottom sealing portion 310 of stem 124 when the pressable valve 120 is released. In various aspects, the spring 202 can bias pressable valve 120 to the closed configuration 300.

The bottom sealing portion 310 can comprise one or more grooves 318 configured to capture one or more sealing members 312 (e.g., an O-ring). A snap ring 320 and a head 322 can capture or trap the ends of the stem 124 to keep the stem 124 within the sensor housing 106. In other words, the pressable valve 120 extends from the head 322 (e.g., button) to a snap ring 320 at the opposite end of stem 124. The head 322 is configured to be pressed by an operator to move the stem 124 and unseal the pressable valve 120. When the head 322 is pressed by the operator, the stem 124 moves a first groove 318a and a second groove 318b of the grooves 318 to unseal the pressable valve 120. The spring 202 extends through a spring seating area 324 of the stem bore 326. That is, a portion of the stem bore 326 can comprise a larger diameter to accommodate the spring 202 when the head 322 is pressed, and a second portion of the stem bore 326 can receive the stem 124 and be configured to seal the pressable valve 120 in the closed configuration and unseal the pressable valve 120 in the open configuration 400.

The pressable valve 120 can comprise the bottom sealing portion 310 and/or a sealing member 312. In some aspects, pressable valve 120 can comprise the lower sealing member 312a, such as the O-ring at the bottom sealing portion 310, and the stem 124 can comprise an upper sealing member 312b, as shown in FIG. 4. The lower sealing member 312a can fluidly seal the fluid within the sensor housing 106 in the closed configuration until the pressable valve 120 is selectively moved into the open configuration 400. In the open configuration, the upper sealing member 312b can seal the fluid from traveling up the stem 124 and force the fluid along the stem 124 and out the flow path 308. For example, the movement of stem 124 from the closed configuration 300 to the open configuration can break the seal of the bottom sealing portion 310 and/or sealing member(s) 312. As shown, bottom sealing portion 310 and sealing member 312a move to break the seal, and sealing member 312b seals an upper part of the stem in the open configuration 400. Specifically, when the stem 124 is moved into the open configuration 400, the groove(s) 318 move sealing portions of the stem 124 (e.g., sealing member(s) 312) to unseal the pressable valve 120 and facilitate the escape of compressible fluid through or about the pressable valve 120 and out the flow path 308.

The diameter of the stem 124 can vary. Specifically, at or below the bottom sealing portion 310 and the lower sealing member 312a, the stem 124 can comprise a first diameter 314 to seal the sealing member 312 and/or bottom sealing portion 310 in the closed configuration 300. When the stem 124 is selectively translated into the open configuration 400, a second diameter 316 of stem 124 can move through the stem bore 326 formed at an interior of sensor housing 106. The second diameter 316 of stem 124 can provide a smaller diameter than the first diameter 314 of stem 124. When the second diameter 316 of stem 124 forms a smaller diameter than the stem bore 326, the second diameter 316 can create an extended or elongated flow path 402 through a portion of sensor housing 106. For example, the stem bore 326 can comprise a spring seating area 324 and the stem 124 can extend through the stem bore 326. For example, the elongated flow path 402 can extend up the second diameter 316 of stem 124 adjacent and about the stem 124 and then out the flow path 308 to the flow path exit 130.

The upper portion of the stem 124, e.g., at or near the spring 202, the diameter can be greater than the second diameter 316. For example, the diameter of stem 124 at or near the spring 202 can be equal to the first diameter 314. The pipe 104 and/or sensor housing 106 can be bled to remove and release a pressurized compressible fluid from an incompressible working fluid in the sensor assembly 102.

The sensor assembly 102 can selectively move stem 124 from the closed configuration 300 to the open configuration 400, for example, when an operator depresses pressable valve 120. In the closed configuration 300, incompressible and compressible fluids can be trapped within sensor housing 106. When compressible fluid is lodged or trapped adjacent to sensor 302, the accuracy of the sensor and/or the quality of the signal generated by sensor 302 can be degraded. To enhance the accuracy of the signal, an operator can compress the pressable valve 120 to move the stem 124 from the closed configuration 300 to the open configuration 400 and release the compressed fluids trapped in the system. In some aspects, removing the compressible fluid from system 100 enhances the operation of system 100 and facilitates monitoring and/or maintenance of system 100. In various aspects, the pressable valve 120 can comprise the stem 124 that defines at least a portion of the elongated flow path 402 through the sensor housing 106. For example, at least a portion of the elongated flow path 402 in the open configuration 400 extends about the stem 124.

In various aspects, pressable valve 120 comprises stem 124, defining at least a portion of the elongated flow path 402. For example, the transverse flow path 308 can fluidly couple to a portion of compressed stem 124 to form elongated flow path 402, and a portion of the elongated flow path 402 extends through and/or about the stem 124. A portion of a transverse flow path 308 can fluidly couple to a bore surrounding stem 124 to form the elongated flow path 402. The pressable valve 120 can move the stem 124 and/or define the flow path through the sensor housing 106 to allow, e.g., a trapped compressible fluid (or other fluid) in the sensor housing 106 to escape through the elongated flow path 402 about the stem 124 and out of sensor housing 106 through transverse flow path 308.

The pressable valve 120 can also comprise a bias element, shown as spring 202, that maintains the pressable valve 120 in the closed configuration 300 until the operator compresses the pressable valve 120. The pressable valve 120 can comprise one or more bias elements that maintain the pressable valve 120 in the closed configuration 300. When the pressable valve is translated and/or compressed into the open configuration 400, the operator overcomes the bias to selectively move and/or translate the pressable valve 120 from the closed configuration to the open configuration 400. In some aspects, this process can be analogous to “bleeding” the compressible fluids in pipe 104 adjacent to sensor 302 to remove the trapped gases within system 100.

As illustrated, the bias element is spring 202, but other bias elements can be employed to return the stem 124 to the closed configuration 300 when an operator has not activated the pressable valve 120. The pressable valve 120 comprises the stem 124 extending through the spring 202 such that the spring surrounds the stem 124 in the open configuration 400 and the closed configuration 300. A sealing member 312 (e.g., an O-ring) can be coupled to stem 124 to form a releasable seal at the lower sealing member 312a. In the closed configuration 300, the sealing member 312a can fluidly couple and seal the stem 124 and/or trap the fluid within the interior of sensor housing 106. In the open configuration 400, the pressable valve 120 can be translated to break the seal of the sealing member 312a within the sensor housing 106, and the sealing member 312b can seal the stem 124 from the flow path 308 to redirect the escaping fluids in a direction different from the central axis 128 of pressable valve 120.

In various aspects, sensor 302 can comprise one or more of the following sensors hydrophones, vibration sensors, flow sensors, pressure sensors, pressure transducers, velocity sensors, flow meters, temperature sensors, turbidity sensors, pH sensors, dissolved oxygen sensors, level sensors, water quality sensors, leak detection sensors, acoustic emission sensors, PH sensors, chemical sensors, temperature sensors, strain gauges, noise loggers, and/or remote field eddy current sensors. Sensors 302 can comprise strain gauges, capacitive sensors, and/or piezoelectric pressure sensors to measure parameters of water pressure in the pipe to detect leaks, bursts, etc. Sensors 302, like RTDs or thermocouples, can measure parameters related to the temperature of water in the pipe, e.g., for monitoring water quality. Optical sensors 302 can measure parameters of fluid turbidity. For example, optical sensors 302 can measure parameters related to water clarity and detect suspended solids to assess water quality. Electrochemical sensors 302 can measure parameters of acidity or alkalinity of the fluid, such as a pH parameter. Optical or electrochemical sensors 302 can measure Dissolved Oxygen (DO) parameters and/or levels to indicate water quality and/or potability. Various sensors 302 are typically used to measure water quality and can comprise multi-parameter probes that measure pH, turbidity, DO, and/or conductivity. In summary, fluid quality and/or leak detection sensors 302 can measure various parameters to detect and locate the fluid's leaks or quality (e.g., water potability).

Sensor 302 can be a piezoelectric sensor 302 configured to measure at least one parameter of a wave frequency. For example, the sensor 302 can comprise a wide frequency response range, allowing detection of infrasound signals (e.g., below 20 Hz) to ultrasound signals (e.g., above 20,000 Hz) and can measure noise pollution in oceans, lakes, rivers, etc. In some aspects, sensor 302, such as a directional hydrophone, can pinpoint the source of an underwater sound, such as a cracked pipe 104, a leaking valve, and/or a damaged fitting. Multiple sensors 302 (e.g., advanced hydrophone arrays) can comprise arrays of sensors 302 coupled to a network to enhance accuracy and/or track underwater objects, water quality, and/or leaks by triangulating the sound and/or measuring a plurality of fluid parameters.

Various sensor(s) 302 can be selected to monitor various fluid parameters. In various aspects, different sensors 302 can measure different fluid parameters in pipe 104. For example, a first sensor 302 can measure a parameter such as the fluid flow rate in the pipe, and a second sensor 302 can measure the vibration and/or sound waves. Sensor 302 can be a hydrophone or an underwater microphone used to detect and monitor sound in water environments. Sensor 302 can be a piezoelectric sensor that converts water pressure changes into electrical signals. For example, the pressure changes can cause sound waves detected by the sensor 302 (e.g., hydrophone) and can record underwater sounds.

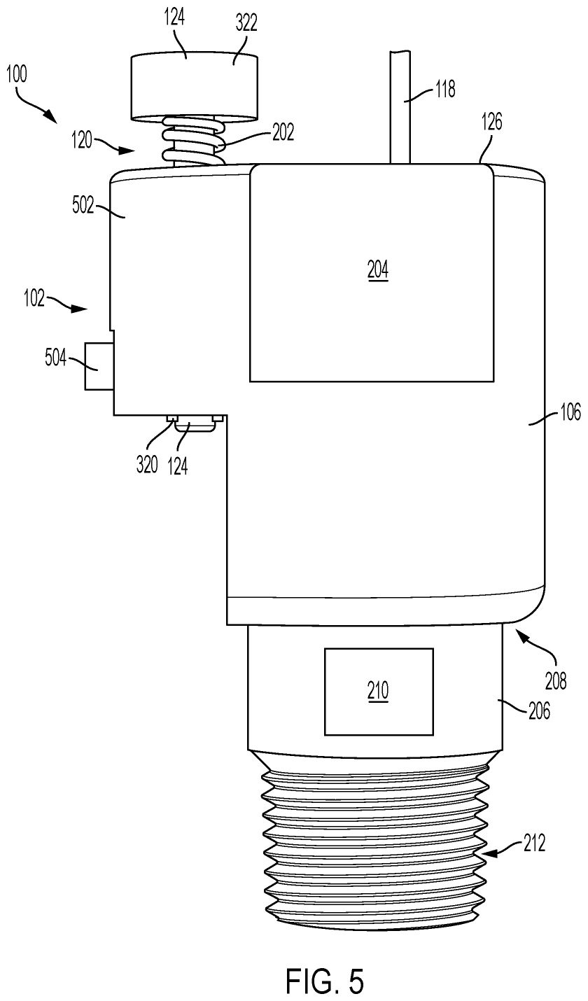

FIG. 5 is an elevated side view of another sensor assembly 102, with sensor housing 106. As shown, the sensor housing 106 is the same as or similar to the sensor housing 106 of FIG. 1, except that the sensor housing 106 comprises an extension 502 with a modified, extended flow path.

Stem 124 comprises spring 202 and extends through the sensor assembly 102, and tool landing surface 204 facilitates a user to rotate sensor assembly 102 onto system 100 with modular tool surface 210. Similarly, electric cable 118 extends through lower cap 112 to electronically couple to sensor 302. A fastener, such as a bolt 504, can be coupled to one side of sensor housing 106 to divert the flow path of the compressible fluid out of sensor housing 106. The modular connector 206 can extend from bottom 208 to the modular tool surface 210 and provide a way to secure sensor housing 106 onto various fittings, e.g., of different sizes and/or threading.

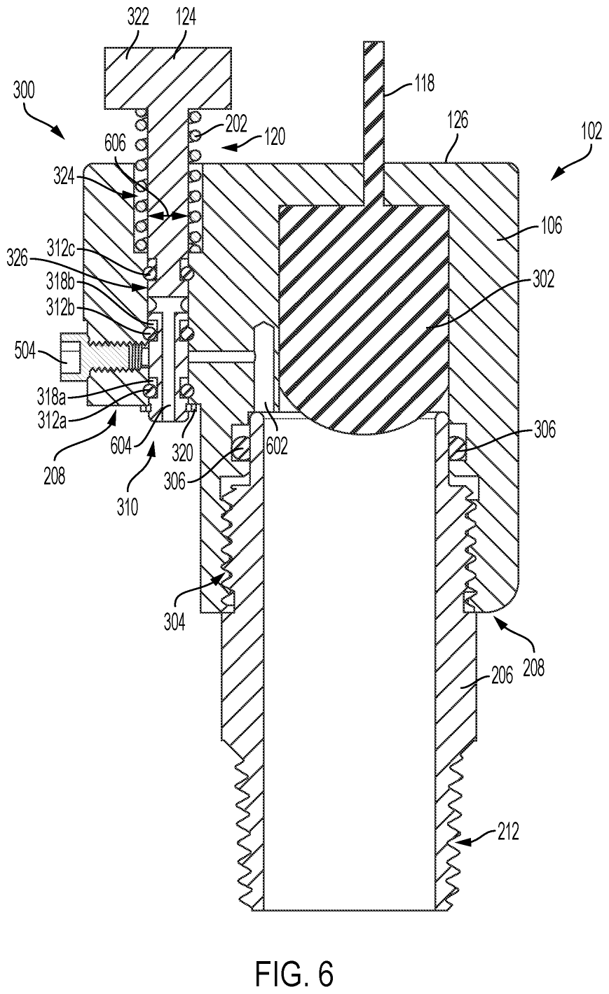

FIG. 6 is a cross-sectional view of the sensor assembly of FIG. 5 in a closed configuration 300. FIG. 6 is taken along the axis line 3-3 of FIG. 1. Sensor housing 106 can receive and/or secure electric cable 118 within the interior of sensor housing 106. Sensor 302 extends through sensor housing 106 (e.g., via electric cable 118) and can be electronically coupled, e.g., to a network or a computer, to send or receive electronic signals through electric cable 118. Inner seal 306 extends around modular connector 206, and inner threads 304 can threadedly couple modular connector 206 to sensor housing 106.

An internal cavity 602 receives fluids, such as incompressible fluids, emitted from pipe 104 and transports them towards stem 124. Stem 124 is coupled to sensor housing 106 with spring 202. Stem 124 can comprise an internal channel 604 that can guide the fluid in internal cavity 602 through the stem 124 and out of sensor housing 106 when stem 124 is compressed and/or moved from the closed configuration 300 to the open configuration 400.

Stem 124 can comprise three sealing members. For example, stem 124 comprises lower sealing member 312a and upper sealing member 312b above and below internal channel 604 but can also comprise a stem sealing member 312c extending along stem 124 above upper sealing member 312b. As shown, the bolt 504 can seal and redirect the fluid flow out of internal channel 604 of stem 124, and/or the bolt 504, can be removed. For example, the bolt 504 can be removed from sensor housing 106 to change the flow path through stem 124 and/or provide an alternative flow direction for escaping fluid when stem 124 is compressed, and the pressable valve 120 is moved to the open configuration 400.

In the aspect shown, stem diameter 606 of stem 124 can remain constant, e.g., above stem sealing member 312c and between stem sealing member 312c to lower sealing member 312a and to an end of internal channel 604. In other aspects, stem diameter 606 can vary or change to facilitate the opening and/or closing of the escaping flow path. In some aspects, the stem bore 326 extends through the extension 502 of sensor housing 106 from the top surface 126 to the bottom 208 of the extension 502.

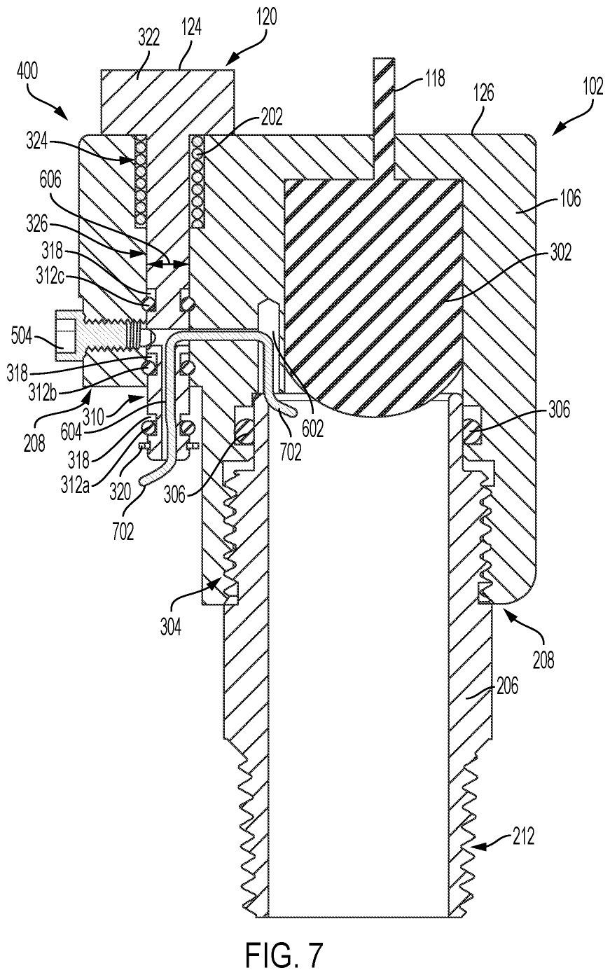

FIG. 7 is a cross-sectional view of the sensor assembly 102 of FIG. 5 in the open configuration 400, shown with stem 124 depressed to open an escape path 702. When stem 124 is depressed near or adjacent to top surface 126, spring 202 compresses within sensor housing 106, and the stem diameter 606 of the stem is complementary to stem bore 326 within sensor housing 106, such that the escape path 702 is opened through the internal channel 604 through the lower portion of stem 124, e.g., between stem sealing member 312c and lower sealing member 312a. The escape path 702 extends through the internal channel 604 extending through a portion of stem 124 above upper sealing member 312b and lower sealing member 312a. Stem sealing member 312c and/or upper sealing member 312b remain within sensor housing 106 in the open configuration 400. In some aspects, lower sealing member 312a can exit stem bore 326 within sensor housing 106 in the open configuration 400. The bottom sealing portion 310 can form with the bottom 208 of sensor housing 106, but in the open configuration 400, the bottom sealing portion 310 can extend below the bottom 208 of sensor housing 106.

The escape path 702 extends through internal cavity 602 and internal channel 604 of stem 124, where the escape path 702 can be deflected by the bolt 504, and the fluid escapes through the bottom of stem 124 that is deflected away from the operator, e.g., away from the side or top of the sensor assembly 102. In various aspects, inner seal 306 can create a seal between modular connector 206 and sensor housing 106, and modular tool surface 210 can threadedly couple to a fitting to attach sensor assembly 102.

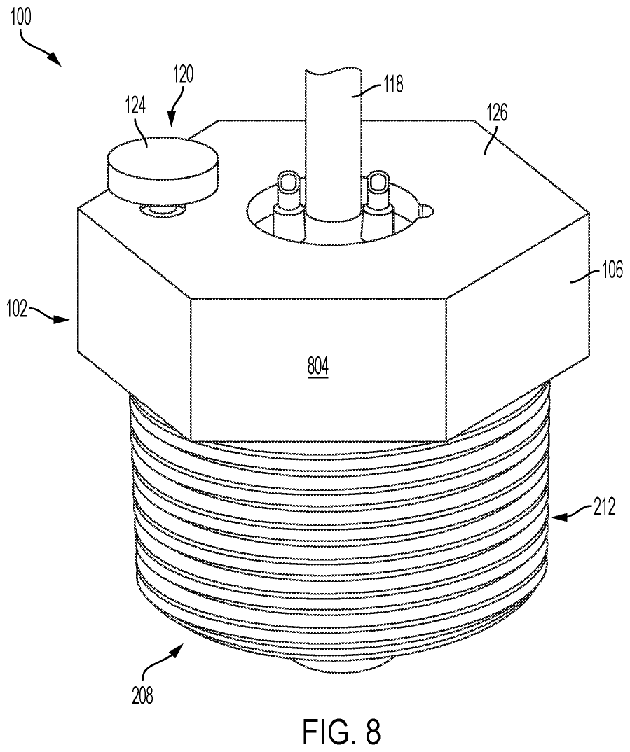

FIG. 8 is an elevated side view of another sensor assembly 102. Similar to other sensor assemblies 102 described herein, stem 124 can be compressed to open an escape path through a sensor housing 106. As shown, the sensor housing 106 can comprise one or more angled surfaces 804, for example, to allow the sensor housing 106 to be engaged and turned by a wrench. In the specific aspect shown in FIG. 8, the one or more angled surfaces 804 are hexagonal, but other aspects contemplate more or fewer angled surfaces 804 and can form a rectangular, pentagonal, hexagonal, octagonal, or another suitable shape. For example, the shape of the sensor housing 106 defined by the angled surfaces 804 can accommodate wrenches on the sensor housing 106 and facilitate the coupling of the sensor housing 106 to a pipe and/or fitting.

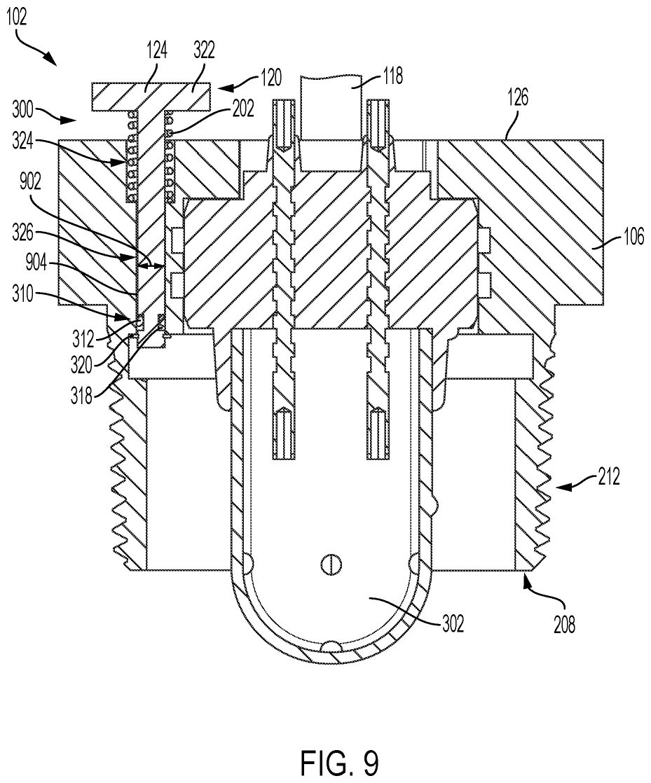

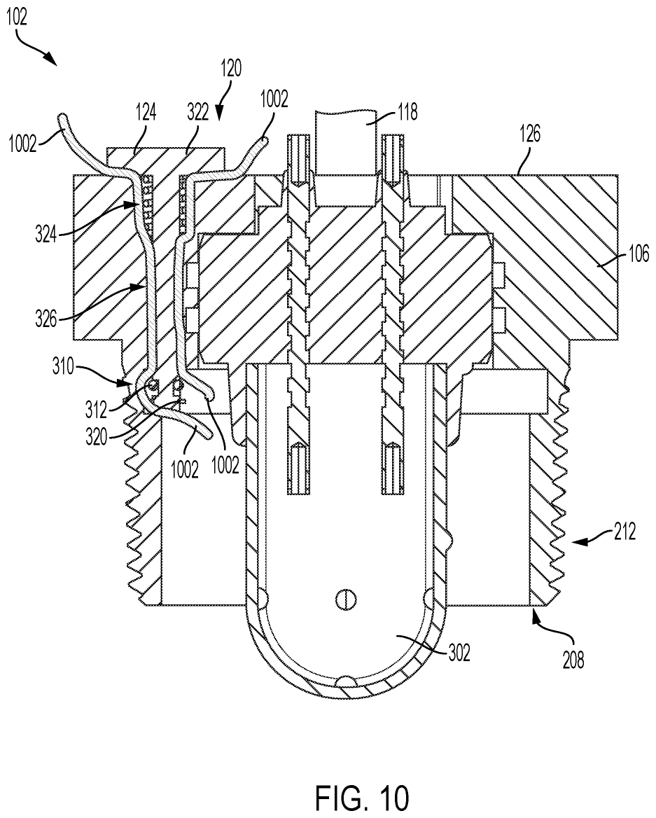

FIGS. 9 and 10 are cross-sectional views of the sensor assembly 102 of FIG. 8 in the closed configuration 300 and the open configuration 400, respectively. FIGS. 9 and 10 are taken along the axis line 3-3 of FIG. 1 to provide similar perspectives of the sensor assembly 102 in the closed configuration 300 and the open configuration 400, respectively.

Compressible valve 120 comprises stem 124 that defines a stem diameter 902. Stem diameter 902 may be smaller than a bore 904 defined in sensor housing 106. Stem 124 comprises an operator-pressable button near the top surface 126 of the sensor housing 106 and the bottom sealing portion 310 (e.g., with lower sealing member 312a) at or near the bottom of stem 124. Electric cable 118 can extend through the top surface 126 of the sensor housing 106, and modular tool surface 210 (FIG. 2) can couple sensor housing 106 to a fitting. In some aspects, modular tool surface 210 can couple to modular connector 206 and may comprise internal and/or external threads. Electric cable 118 extends through top surface 126, and sensor 302 extends below bottom 208, e.g., into the working fluid of pipe 104 or a suitable fitting. The stem 124 can be pushed to compress the spring 202 and move the stem 124 from the closed configuration 300, as shown in FIG. 9, to the open configuration 400, as shown in FIG. 10. In the closed configuration 300, bottom sealing portion 310 and/or lower sealing member 312 can be located within sensor housing 106 (e.g., within a bore 904 similar to stem bore 326 housing the stem 124).

When stem 124 is compressed, as shown in FIG. 10, an escape path 1002 can surround stem 124. In various aspects, escape path 1002 can define a plurality of escape paths 1002a and/or 1002b on either side of bottom sealing portion 310. The escape path 1002 follows through sensor housing 106 in the same direction as bore 904 and is facilitated by stem diameter 902.

Also disclosed is a method comprising coupling sensor assembly 102 to pipe 104 to bleed pipe 104 of a compressible fluid. The sensor assembly 102 can comprise sensor 302 and a pressable valve 120 in sensor housing 106. The operator can depress the pressable valve 120 to selectively move the pressable valve 120 from the closed configuration 300 to the open configuration 400 to release a pressurized compressible fluid in the sensor housing 106.

In various aspects, the operator can release the pressable valve 120 to selectively move and/or translate the pressable valve 120 from the open configuration 400 to the closed configuration 300. Depressing the pressable valve 120 ejects the compressible fluid from the pipe 104 and/or sensor housing 106. In some aspects, the pressable valve 120 defines the central axis 128 within the sensor housing 106, and the fluid can be ejected from the pipe 104 and be oriented in a non-axial direction relative to the central axis 128 to prevent releasing the compressed fluid in the operator's direction.

The description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B,” as used herein, means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements, and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Any process descriptions or blocks in flow diagrams should be understood as representing modules, segments, or portions of code which comprise one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. A sensor assembly comprising:
a sensor housing configured to couple to a pipe:
a sensor mounted on the sensor housing and configured to measure a parameter; and
a pressable valve mounted on the sensor housing and selectively movable from a closed configuration to an open configuration.

2. The sensor assembly of claim 1, wherein the sensor housing defines a top surface, and the pressable valve extends through the top surface within the sensor housing.

3. The sensor assembly of claim 1, wherein the pressable valve defines a central axis and the pressable valve defines a transverse flow path in the open configuration, and wherein the transverse flow path directs an escaping fluid out of the sensor housing in a direction that is substantially transverse to the central axis.

4. The sensor assembly of claim 1, wherein the sensor assembly is coupled to a modular connector that couples to an inner portion of the sensor housing, the modular connector configured to mount to the sensor housing on the pipe.

5. The sensor assembly of claim 1, wherein the sensor is a piezoelectric sensor configured to measure at least one parameter of a wave frequency.

6. The sensor assembly of claim 1, wherein the sensor is selected from a group consisting of a hydrophone, a vibration sensor, a pressure transducer, a flow meter, an acoustic emission sensor, a PH sensor, a chemical sensor, a temperature sensor, a strain gauge, a noise logger, and a remote field eddy current sensor.

7. The sensor assembly of claim 1, wherein in the open configuration:
the pressable valve comprises a stem defining a flow path; and
a portion of the flow path extends through the stem.

8. The sensor assembly of claim 1, wherein in the open configuration:
the pressable valve comprises a stem defining a flow path; and
a portion of the flow path extends about the stem.

9. The sensor assembly of claim 1, wherein when an operator moves the stem into an open configuration, the stem defines the flow path through the sensor housing, and a compressible fluid trapped in the sensor housing escapes from the flow path.

10. The sensor assembly of claim 1, wherein the pressable valve comprises a bias element that maintains the pressable valve in the closed configuration, and in the open configuration, a user overcomes a bias to selectively move the pressable valve from the closed configuration to the open configuration.

11. The sensor assembly of claim 10, wherein the bias element is a spring and the pressable valve further comprises:
a stem extending through the spring such that the spring surrounds the stem; and
an O-ring coupled to the stem.

12. The sensor assembly of claim 11, wherein:
in the closed configuration, an O-ring couples to the stem to form a seal within the sensor housing; and
in the open configuration, the pressable valve translates to break the seal of the O-ring within the sensor housing.

13. The sensor assembly of claim 1, wherein in the open configuration the pressable valve defines an escape path extending through a portion of the sensor housing and a portion of the stem.

14. A system comprising:
a pipe conducting a fluid;
a sensor housing coupled to the pipe;
a sensor mounted on the sensor housing and configured to measure a parameter of the fluid within the pipe; and
a pressable valve mounted on the sensor housing and selectively movable from a closed configuration to an open configuration.

15. The system of claim 14, wherein the pressable valve extends through a top surface of the sensor housing.

16. The system of claim 14, wherein the sensor housing defines a central axis and a flow path ejects compressible fluid from the pipe in a direction different from an axial direction of the central axis.

17. The system of claim 14, wherein in the open configuration:
the pressable valve comprises a stem defining a flow path; and
a portion of the flow path extends about the stem.

18. The system of claim 14, wherein in the open configuration:
the pressable valve comprises a stem defining a flow path; and
a portion of the flow path extends through the stem.

19. The system of claim 14, wherein the pressable valve comprises a bias element that maintains the pressable valve in the closed configuration.

20. A method comprising:
coupling a sensor assembly to a pipe, the sensor assembly comprising a sensor and a pressable valve within a sensor housing; and
depressing the pressable valve to selectively move the pressable valve from a closed configuration to an open configuration.

21. The method of claim 20, further comprising releasing the pressable valve to selectively move the pressable valve from the open configuration to the closed configuration.

22. The method of claim 20, wherein depressing the pressable valve ejects a compressible fluid from the pipe.

23. The method of claim 22, wherein the pressable valve defines an axis within the sensor housing and the compressible fluid ejected from the pipe is oriented in a non-axial direction relative to the axis.
